(19) United States
(12) Patent Application Publication
(10) Pub. No.: US 2014/0359759 A1
(43) Pub. Date: Dec. 4, 2014

(54) FRAUDULENT DATA DETECTOR

(71) Applicant: INTERNATIONAL BUSINESS MACHINES CORPORATION, Armonk, NY (US)

(72) Inventor: PATRICK A. FAGAN, NAAS (IE)

(73) Assignee: INTERNATIONAL BUSINESS MACHINES CORPORATION, Armonk, NY (US)

(21) Appl. No.: 14/255,547

(22) Filed: Apr. 17, 2014

(30) Foreign Application Priority Data
Jun. 3, 2013 (GB) 1309875.1

(51) Int. Cl. G06F 21/00

(52) U.S. Cl. CPC G06F 21/00
USPC 726/22

(57) ABSTRACT

An apparatus identifies suspicious data records having two or more numerical fields. A first hardware selector identifies a set of records for analysis. A second hardware selector identifies fields within identified records that are appropriate for a Benford analysis. A Benford analysis engine calculates, for each identified field, a Benford distribution for each identified field. A hardware aggregator sums a total score for each record from the set of records, where each total score comprises a summation of deviant values for each appropriate field value within each record, and where a deviant value represents a difference between a calculated Benford distribution for each field and a theoretical Benford distribution for each field. A third hardware selector selects a record from the set of records according to a highest total score.

### BACKGROUND

This invention relates to a method and apparatus for detection of fraudulent data in a statistically significant data set. In particular this relates to a method and apparatus for the application of Benford's law to large but sparse data sets.

Benford's law is a mathematical theory that states that the distribution of the first digit of numbers from man-made sources follows a specific pattern. It has been used to detect likely fraud in many fields where the data sets for an individual record is large enough for it to be successfully applied. However, there may be many sparsely populated fields where an individual record does not contain a large enough data set for Benford's law to be applied.

### SUMMARY

In one embodiment of the present invention, an apparatus identifies suspicious data records, said records comprising two or more numerical fields, said apparatus comprising: a first hardware selector for identifying a set of records for analysis; a second hardware selector for identifying fields within identified records that are appropriate for a Benford analysis; a Benford analysis engine for calculating, for each identified field, a Benford distribution for said each identified field; a hardware aggregator for summing a total score for each record from the set of records, each total score comprising a summation of deviant values for each appropriate field value within said each record, a deviant value representing a difference between a calculated Benford distribution for said each field and a theoretical Benford distribution for said each field; and a third hardware selector for selecting a record from the set of records according to a highest said total score.

In one embodiment of the present invention, a method identifies suspicious data records, each record comprising two or more numerical fields. The method comprises: identifying, by one or more processors, a set of records to be aggregated for analysis; identifying, by one or more processors, fields within identified records, from the set of records, that are appropriate for a Benford analysis; calculating, by one or more processors, a Benford distribution for each identified field; summing, by one or more processors, a total score for each record from the set of records, wherein each total score comprises a summation of deviant values for each appropriate field value within said each record, wherein a deviant value represents a difference between a calculated Benford distribution for said each field and a theoretical Benford distribution for said each field; and selecting, by one or more processors, a record from the set of records according to a highest said total score.

In one embodiment of the present invention, a computer program product identifies suspicious data records, each record comprising two or more numerical fields, the computer program product comprising a computer-readable storage medium having program code embodied therewith, the program code readable and executable by a processor to perform a method comprising: identifying a set of records to be aggregated for analysis; identifying fields within the identified records that are appropriate for a Benford analysis; calculating, for each identified field, a Benford distribution for said each identified field; summing a total score for each record from the set of record, wherein each total score comprises a summation of deviant values for each appropriate field value within said each record, wherein a deviant value represents a difference between a calculated Benford distribution for said each field and a theoretical Benford distribution for said each field; and selecting records from the set of records according to a highest said total score.

### BRIEF DESCRIPTION OF THE SEVERAL VIEWS OF THE DRAWINGS

Preferred embodiments of the present invention will now be described, by way of example only, with reference to the following drawings in which:

FIG. 1 is a deployment diagram of a preferred embodiment;

FIG. 2 is a component diagram of a preferred embodiment;

FIG. 3 is a flow diagram of a process of a preferred embodiment;

FIG. 4 to FIG. 7 are examples of data processed by a preferred embodiment; and

FIG. 8 is a deployment diagram of a client server embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present invention describes a method that allows Benford's law to be applied to very sparse data sets. The most straight forward statement of Benford's law gives a table of the probabilities of a leading digit of a human generated number:

| Leading | Probability |
|---|---|
| Digit | (as percentage) |
| 1 | 30% |
| 2 | 18% |
| 3 | 13% |
| 4 | 10% |
| 5 | 8% |
| 6 | 7% |
| 7 | 6% |
| 8 | 5% |
| 9 | 5% |

This is referred to as a theoretical Benford distribution. Benford's law can also be applied beyond the first digit to the second and third digit or combination of these, which will improve the accuracy of the results.

In order to successfully apply Benford's law some criteria needs to be met: 1) the data set needs to be large enough to produce a statistically significant result. For the examples in this invention a typical value of at least 30 data points has been used. This holds where the data has a normal distribution and has not been rounded. 2) The data points cannot be bounded by upper or lower limits that constrain the potential values to a range smaller than several orders of magnitude. These criteria are discussed in known prior art.

Typical applications of Benford's law tend to focus on data sets where there is sufficient data to apply it directly to a single document or return, for example a tax return. The key to this type of application is that the data set from the single document or return needs to be large enough to produce a statistically significant result. Any document or return where the data does not fit within the distribution of first digits as predicted by Benford's law, are then considered as potentially fraudulent. This information is typically combined with other indicators of potential fraud to direct investigations.

Many situations generate data sets which are not large enough to produce a statistically significant result, when applying Benford's law. For example, consider a claim form for a social security benefit like Food Stamps, while there are many numerical fields that may be completed, the typical claim will only have a small number of these fields completed. Based on 2009 figures, a single person earning over $667 a month would be ineligible for Food Stamps, meaning that if you have a lot of financial resources to list on the form, you are unlikely to be eligible. Directly applying Benford's law to data sets like this is not possible. For example, compiling the figures for a social security claim form into a table, the result would be much like the one below. Note that no row would have the 30, or more, completed fields to allow Benford's law to be applied directly.

This present invention addresses at least one situation where Benford's law is not normal applicable.

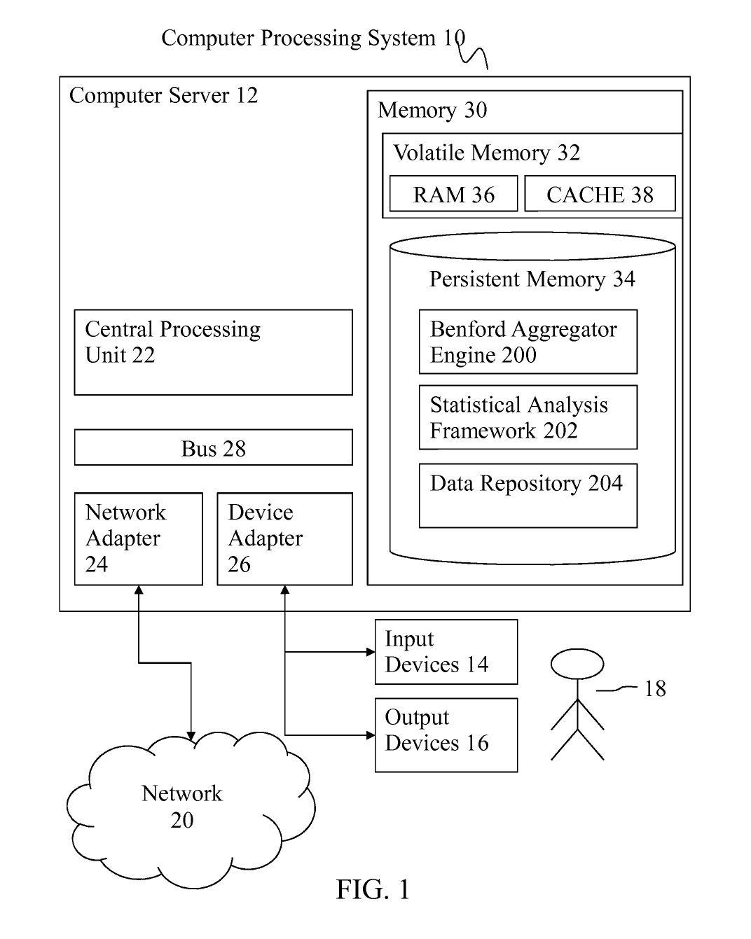

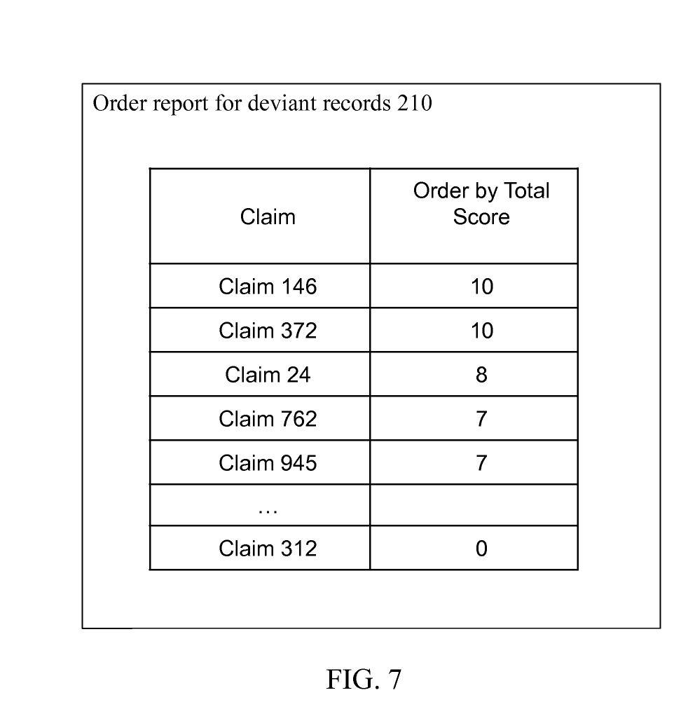

Referring now to FIG. 1, the deployment of a preferred embodiment in a computer processing system 10 is described. A further embodiment in a client server computer processing system is shown in FIG. 7 that would be more typical for data sets stored on a local computer. Other embodiments are envisaged where a client front end is located on one computer, the data on another and the processing on a further computer as would be more typical for a very large data set and for distributed computing environment. An Internet enabled embodiment would send a client front end document to a client device for access to the results. All these embodiments are variations of a preferred embodiment now described.

Computer processing system 10 of a preferred embodiment is operational with numerous other general purpose or special purpose computing system environments or configurations. Examples of well-known computing processing systems, environments, and/or configurations that may be suitable for use with computer processing system 10 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer processing system 10 may be described in the general context of computer system-executable instructions, such as program modules, being executed by a computer processor. Generally, program modules may include routines, programs, objects, components, logic, and data structures that perform particular tasks or implement particular abstract data types. Computer processing system 10 may be embodied in distributed cloud computing environments where tasks are performed by remote processing devices that are linked through a communications network. In a distributed cloud computing environment, program modules may be located in both local and remote computer system storage media including memory storage devices.

Computer processing system 10 comprises: general-purpose computer server 12 and one or more input devices 14 and output devices 16 directly attached to the computer server 12. Computer processing system 10 is connected to a network 20. Computer processing system 10 communicates with a user 18 using input devices 14 and output devices 16. Input devices 14 include one or more of: a keyboard, a scanner, a mouse, trackball or another pointing device. Output devices 16 include one or more of a display or a printer. Computer processing system 10 communicates with network devices (not shown) over network 20. Network 20 can be a local area network (LAN), a wide area network (WAN), or the Internet.

Computer server 12 comprises: central processing unit (CPU) 22; network adapter 24; device adapter 26; bus 28 and memory 30.

CPU 22 loads machine instructions from memory 30 and performs machine operations in response to the instructions. Such machine operations include: incrementing or decrementing a value in register (not shown); transferring a value from memory 30 to a register or vice versa; taking instructions from a different location in memory if a condition is true or false (also known as a conditional branch instruction); and adding or subtracting the values in two different registers and put the result in another register. A typical CPU can perform many different machine operations. A set of machine instructions is called a machine code program, the machine instructions are written in a machine code language which is referred to a low level language. A computer program written in a high level language needs to be compiled to a machine code program before it can be run. Alternatively a machine code program such as a virtual machine or an interpreter can interpret a high level language in terms of machine operations.

Network adapter 24 is connected to bus 28 and network 20 for enabling communication between the computer server 12 and network devices.

Device adapter 26 is connected to bus 28 and input devices 14 and output devices 16 for enabling communication between computer server 12 and input devices 14 and output devices 16.

Bus 28 couples the main system components together including memory 30 to CPU 22. Bus 28 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Memory 30 includes computer system readable media in the form of volatile memory 32 and non-volatile or persistent memory 34. Examples of volatile memory 32 are random access memory (RAM) 36 and cache memory 38. Generally volatile memory is used because it is faster and generally non-volatile memory is used because it will hold the data for longer. Computer processing system 10 may further include other removable and/or non-removable, volatile and/or non-volatile computer system storage media. By way of example only, persistent memory 34 can be provided for reading from and writing to a non-removable, non-volatile magnetic media (not shown and typically a magnetic hard disk or solid-state drive). Although not shown, further storage media may be provided including: an external port for removable, non-volatile solid-state memory; and an optical disk drive for reading from or writing to a removable, non-volatile optical disk such as a compact disk (CD), digital video disk (DVD) or Blu-ray. In such instances, each can be connected to bus 28 by one or more data media interfaces. As will be further depicted and described below, memory 30 may include at least one program product having a set (for example, at least one) of program modules that are configured to carry out the functions of embodiments of the invention.

The set of program modules configured to carry out the functions of a preferred embodiment comprises: Benford aggregator engine 200; statistical analysis framework 202 and data repository 204. Further program modules that support a preferred embodiment but are not shown including firmware, boot strap program, operating system, and support applications. Each of the operating system, support applications, other program modules, and program data or some combination thereof, may include an implementation of a networking environment.

Computer processing system 10 communicates with at least one network 20 (such as a local area network (LAN), a general wide area network (WAN), and/or a public network like the Internet) via network adapter 24. Network adapter 24 communicates with the other components of computer server 12 via bus 28. It should be understood that although not shown, other hardware and/or software components could be used in conjunction with computer processing system 10. Examples, include, but are not limited to: microcode, device drivers, redundant processing units, external disk drive arrays, redundant array of independent disks (RAID), tape drives, and data archival storage systems.

Thus, the hardware depicted in FIG. 1 presents hardware for, but not limited to, a first hardware selector (e.g., CPU 22) for identifying a set of records for analysis; a second hardware selector (e.g., CPU 22) for identifying fields within identified records that are appropriate for a Benford analysis; a Benford analysis engine for calculating, for each identified field, a Benford distribution for said each identified field; a hardware aggregator (e.g., CPU 22) for summing a total score for each record from the set of records, each total score comprising a summation of deviant values for each appropriate field value within said each record, a deviant value representing a difference between a calculated Benford distribution for said each field and a theoretical Benford distribution for said each field; and a third hardware selector (e.g., CPU 22) for selecting a record from the set of records according to a highest said total score.

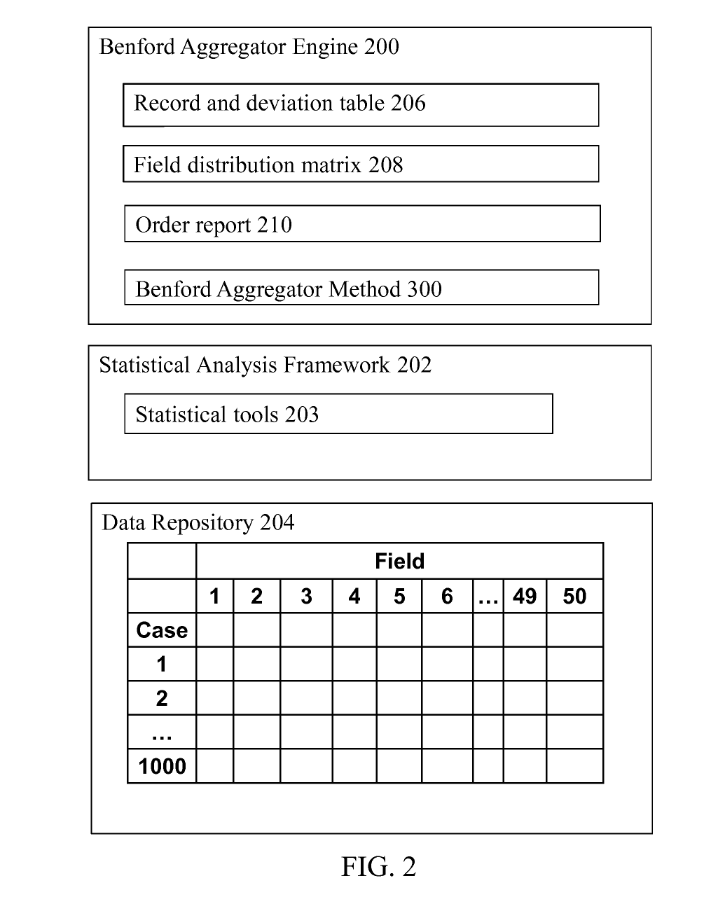

Referring to FIG. 2, Benford aggregator engine 200 comprises: record and deviation table 206; field distribution matrix 208; order report 210; and Benford aggregator method 300.

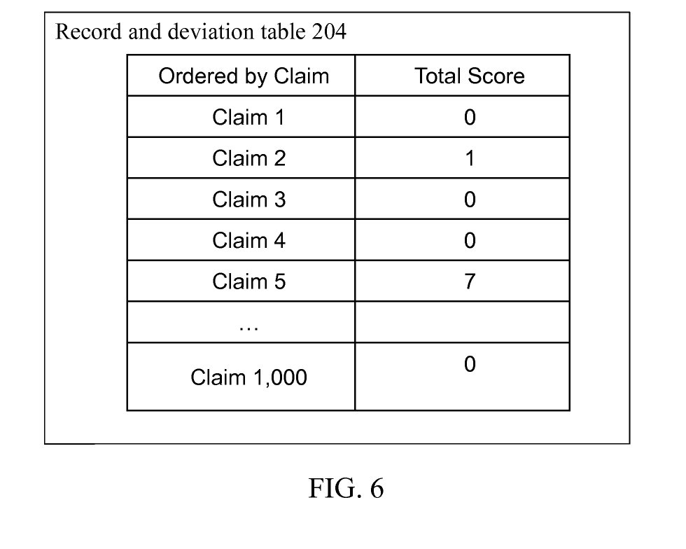

Record and deviation table 206 is for storing references to the selected records and an attribute for measuring the deviation from a predicted Benford score. This is explained in more detail below with reference to the example of FIG. 6.

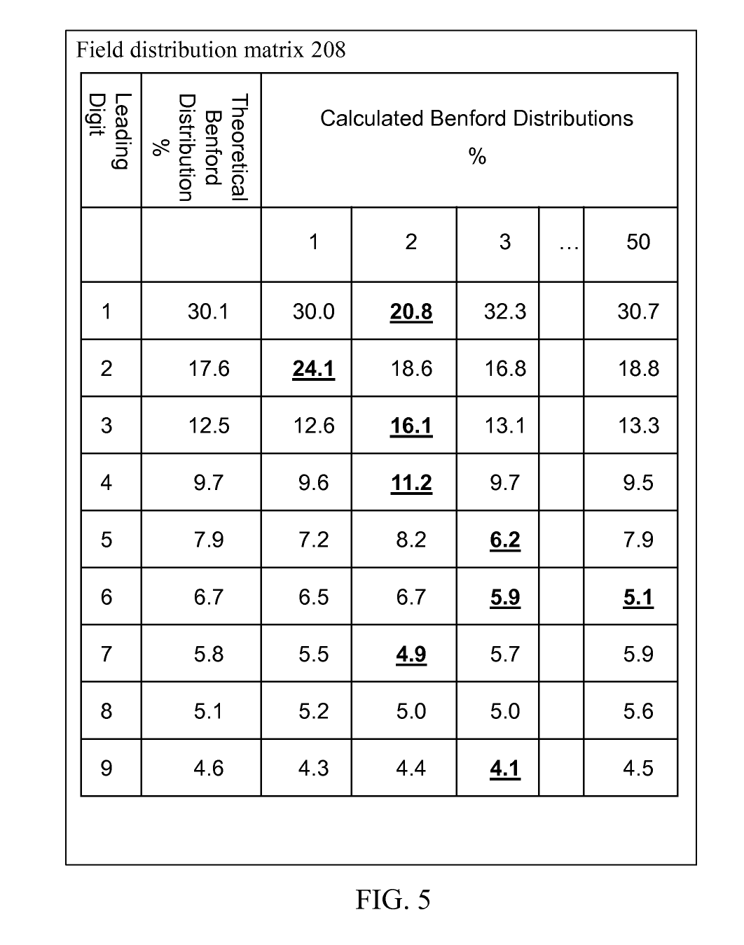

Field distribution matrix 208 is for storing the aggregated results of the Benford categories and the occurrence in each of the fields of the data under analysis. This is explained in more detail below with reference to the example of FIG. 5.

Order report 210 is for storing a list of records prioritized in order by the highest Benford deviation and their highest risk of being fraudulent. This is explained in more detail below with reference to the example of FIG. 7.

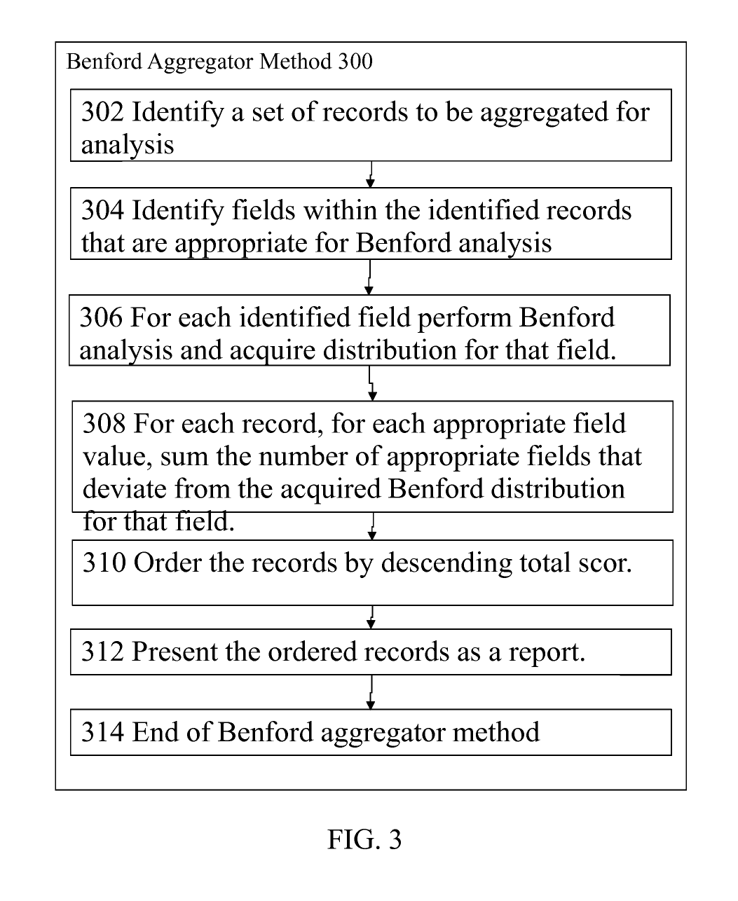

Benford aggregator method 300 is described in more detail below with respect to FIG. 3.

Still referring to FIG. 2, statistical analysis framework 202 comprises statistical tool 203 including a Benford analysis engine that acts on the data and outputs the Benford analysis.

Still referring to FIG. 2, data repository 204 contains user data and in particular a table of records that are to be processed by the embodiments. The records are shown as having multiple fields, the example shows fifty but the embodiments will work with two or more fields.

Referring to FIG. 3, Benford aggregator method 300 comprises logical process steps 302 to 314.

Step 302 is for identifying a set of records to be aggregated for analysis.

Step 304 is for identifying fields within the identified records that are appropriate for Benford analysis. Such fields are those that meet the criteria for Benford's law, for instance, the data set in the field needs to be large enough to produce a statistically significant result. For example, a typical value of at least 30 data points within the field has been used.

Step 306 is for performing, for each identified field, Benford analysis and for acquiring a distribution for that field. In each field, missing values are ignored and a call is made to a Benford engine in statistical analysis framework 202 to perform the analysis. The end result is a distribution (a percentage occurrence) of the leading digit for that field for all the appropriate records (see FIG. 5). A percentage occurrence of a leading digit for each field will differ from a theoretical Benford distribution by an amount.

Step 308 is summing, for each record, the number of times within the record where the occurrence of a leading digit occurs outside an expected range for that digit and for that field. The range for a preferred embodiment is 10% either side of the expected occurrence from Benford law because 10% renders an appropriate number of results. However, tighter or looser tolerances can be chosen depending on the data. This summation leads to a total score for each record (see FIG. 6 and FIG. 7). In a different embodiment normalized values representing the deviations are summed to estimate a total deviation for the record.

Step 310 is for ordering the records by descending total score as acquired in step 308.

Step 312 is for presenting the ordered records as a report.

Step 314 is the end of Benford aggregator method 300.

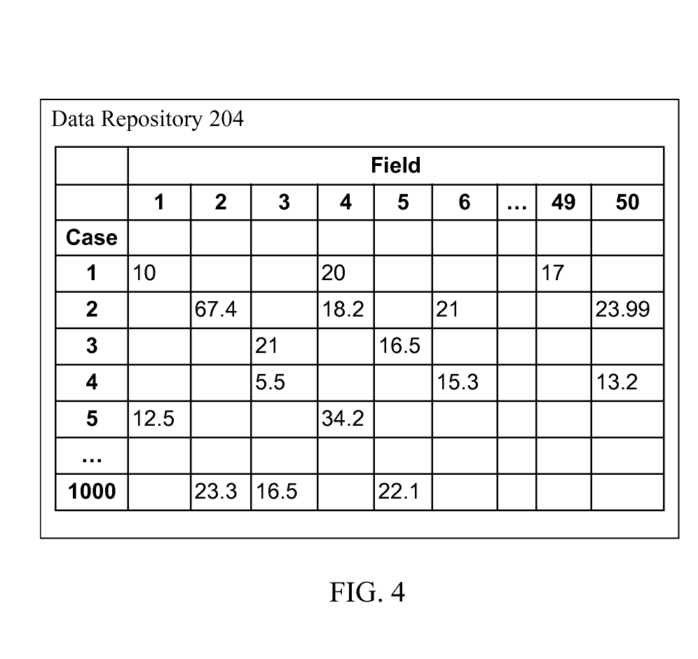

Referring to FIG. 4, data repository 204 comprises a table with records (in this example also called cases): 1, 2, 3, 4, 5 to 1000 whereby records 6 to 999 are not shown. Each record comprises fields: 1, 2, 3, 4, 5, 6 to 49 and 50 whereby fields 7 to 48 are not shown. Case 1 shows three values: 10 for field 1; 20 for field 4; and 17 for field 49. Case 2 shows four values: 67.4 for field 2; 18.2 for field 4; 21 for field 6 and 23.99 for field 50. Case 3 shows two values: 21 for field 3; 16.5 for field 5. Case 4 shows three values: 5.5 for field 3; 15.3 for field 6; and 13.2 for field 50. Case 5 shows two values: 12.5 for field 1; and 34.2 for field 4. Cases 6 to 999 are not shown. Case 1000 shows three values: 23.3 for field 2; 16.5 for field 3 and 22.1 for field 5. The data represents, for instance, a spare set of records that might be collected from a survey.

Referring to FIG. 5, an example field distribution matrix 208 represents a distribution of leading digits that is in theory calculated from the example of FIG. 4. The first column of the table (labeled ‘Leading Digits’) comprises leading digits from 1 to 9. The second column of the table (labeled Theoretical Benford Distribution %′) comprises the theoretical Benford distribution that would be expected from a very large set of data of human generated data. The remaining columns (labeled ‘Calculated Benford Distribution % 1, 2, 3 to 50’) represent the actual calculated Benford distributions for the field values. Some of the probabilities in the field columns are within a threshold of the theoretical Benford distribution and some are not. In a preferred embodiment the threshold is taken to be 10% and values outside of this threshold are highlighted in bold and underlined. The calculated Benford distribution for field 1 shows that occurrences of leading digit 2 are not within the threshold. The calculated Benford distribution for field 2 shows that occurrences of leading digits 1, 3, 4 and 7 are not within the threshold. The calculated Benford distribution for field 3 shows that occurrences of leading digits 5, 6 and 9 are not within the threshold. Columns for fields 4 to 49 are not shown. The calculated Benford distribution for field 50 shows that occurrences of leading digit 6 are not within the threshold.

Referring to FIG. 6, an example record and deviation table 204 comprises a list of records (for examples claims 1 to 1000) with respective total score for the each record. In this embodiment, total score is the total number of times that a leading digit within a field of the record did not match the theoretical Benford distribution. Claim 2 did not match twice. Claim 5 did not match 7 times. All the reset of the claims either matched or were not consider appropriate.

Referring to FIG. 7, an example order report 210 comprises a list of records (the claims of FIG. 6) ordered by descending total score. The example here shows that claims 146 and 372 each have a total score of 10; that is, for record 146 and 372, there are ten occurrences of a leading digit within a field of the record that do not match the theoretical Benford distribution. This highlights claims 146 and 373 as the highest suspected erroneous manipulated data. Claim 24 has eight occurrences of a leading digit within a field of the record that do not match the theoretical Benford distribution. Claims 762 and 945 each have seven occurrences of a leading digit within a field of the record that do not match the theoretical Benford distribution.

Further embodiments of the invention are now described.

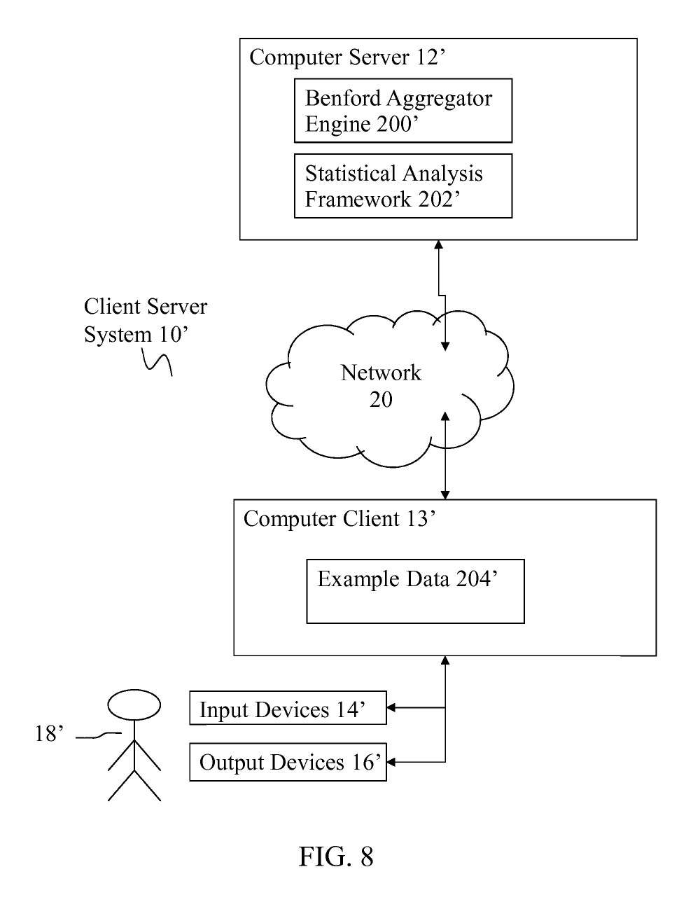

Referring to FIG. 8, a further alternative embodiment of the present invention is shown that may be realized in the form of a client server system 10′ comprising computer server 12′ and computer client 13′. Computer server 12′ comprises Benford aggregator 200′ and statistical analysis framework 202′. Computer server 12′ connects to computer client 13′ via network 20. Computer client 13′ comprising data repository 204′ and provides output via output devices 16′ to user 18′ and received input from user 18′ via input devices 14′. In this client server embodiment, data is located on the client but the processing is located in the computer server 12′. In this client server embodiment, a Benford aggregation service is provided to a client. In a first aspect of the invention there is provided an apparatus for identifying suspicious data records, said records comprising two or more numerical fields, said tool comprising: a first selector for identifying a set of records for analysis; a second selector for identifying fields within the identified records that are appropriate for Benford analysis; a Benford analysis engine for calculating, for each identified field, a Benford distribution for that field; an aggregator for summing a total score for each record, each total score comprising a summation of deviant values for each appropriate field value within that record, a deviant value representing a difference between the calculated Benford distribution for that field and a theoretical Benford distribution; and a third selector for selecting results from the records according to the highest total score.

In a preferred embodiment the deviant value is a binary value that represents whether the deviation from the acquired Benford distribution is within or outside of a threshold deviation from a theoretical Benford distribution. The summation of the deviant values (total score) will therefore be an integer value.

It is envisaged that in another embodiment, that the deviant value is a floating point number that represents a normalized deviation from the acquired Benford distribution for that field. In this other embodiment, the summation of the deviant value (total score) will be a normalized floating point number.

A prior art approach is to take a large number of records as a set and apply Benford's law to this data set. However, a direct application of Benford's law to this data set, would highlight discrepancies that may exist in the large data set without allowing the anomalies to be tracked back to originating documents or returns.

The embodiments take a large number of records as a set and then sub-divide that set by the individual numeric fields used in each record. For each field the data set from all the documents should to be large enough to produce a statistically significant result. The anomalous values identified within a single field, contribute to a small increase in the risk of overall anomaly for the originating documents or returns that contributed them. By totaling the number of anomalous values across the completed fields in each document or return, an assessment of the overall risk can be calculated.

These values will have no abstract meaning, but the documents or returns with the highest values, within a single application of this method, are the most likely to deviate from Benford's law, and can be considered as potentially fraudulent in the same way as would result from the direct application of Benford's law.

Note that a very large number of documents or returns may be needed in order to have a sufficiently large dataset for each field. However, in many situations this would be readily available.

Going back to the example table from earlier, this time looking down the columns, it is clear that over thousands of forms, many of the columns would contain the 30, or more, completed fields to allow Benford's law to be applied.

Advantageously Benford analysis is performed on the leading digit.

More advantageously the deviant value is a binary value that represents whether the deviation from the acquired Benford distribution is within or outside of a threshold deviation.

Most advantageously the threshold deviation is a percentage of the theoretical Benford occurrence.

Even more advantageously the threshold deviation is 10% of the theoretical Benford occurrence.

Preferably Benford analysis is performed on the second leading digit.

More preferably Benford analysis is performed on the third leading digit.

Most preferably Benford analysis is performed on the first and second leading digits.

Even more preferably Benford analysis is performed on a combination of the first, second and third leading digits.

Suitably, the ordered records are presented as a report.

In a second aspect of the invention there is provided a method for identifying suspicious data records, each record comprising two or more numerical fields, said method comprising: identifying a set of records to be aggregated for analysis; identifying fields within the identified records that are appropriate for Benford analysis; calculating, for each identified field, a Benford distribution for that field; summing a total score for each record, each total score comprising a summation of deviant values for each appropriate field value within that record, a deviant value representing a difference between the calculated Benford distribution for that field and a theoretical Benford distribution; and selecting results from the records according to the highest total score.

The embodiments have an effect on statistical processes carried on outside the computer that act on the advantageous aggregation of data. The embodiments have a technical effect that operates at a system level of a computer and below an overlying computer application level that will interpret the results. The embodiments have an effect that leads to an increase in the reliability of data records.

In a third aspect of the invention there is provided a computer program product for identifying suspicious data in data records, the computer program product comprising a computer-readable storage medium having computer-readable program code embodied therewith and the computer-readable program code configured to perform all the steps of the methods.

The computer program product comprises a series of computer-readable instructions either fixed on a tangible medium, such as a computer readable medium, for example, optical disk, magnetic disk, solid-state drive or transmittable to a computer system, using a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

It will be clear to one of ordinary skill in the art that all or part of the logical process steps of a preferred embodiment may be alternatively embodied in a logic apparatus, or a plurality of logic apparatus, comprising logic elements arranged to perform the logical process steps of the method and that such logic elements may comprise hardware components, firmware components or a combination thereof.

It will be equally clear to one of skill in the art that all or part of the logic components of a preferred embodiment may be alternatively embodied in logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In a further alternative embodiment, the present invention may be realized in the form of a computer implemented method of deploying a service comprising steps of deploying computer program code operable to, when deployed into a computer infrastructure and executed thereon, cause the computer system to perform all the steps of the method.

It will be appreciated that the method and components of a preferred embodiment may alternatively be embodied fully or partially in a parallel computing system comprising two or more processors for executing parallel software.

It will be clear to one skilled in the art that many improvements and modifications can be made to the foregoing exemplary embodiment without departing from the scope of the present invention.

What is claimed is:

1. An apparatus for identifying suspicious data records, said records comprising two or more numerical fields, said apparatus comprising:
a first hardware selector for identifying a set of records for analysis;
a second hardware selector for identifying fields within identified records that are appropriate for a Benford analysis;
a Benford analysis engine for calculating, for each identified field, a Benford distribution for said each identified field;
a hardware aggregator for summing a total score for each record from the set of records, each total score comprising a summation of deviant values for each appropriate field value within said each record, a deviant value representing a difference between a calculated Benford distribution for said each field and a theoretical Benford distribution for said each field; and
a third hardware selector for selecting a record from the set of records according to a highest said total score.

2. The apparatus according to claim 1, wherein the Benford analysis is performed on a leading digit of the fields within the identified records.

3. The apparatus according to claim 1, wherein the deviant value is a binary value that represents whether a deviation from an acquired Benford distribution is within or outside of a threshold deviation.

4. The apparatus according to claim 3, wherein the threshold deviation is a percentage of the theoretical Benford distribution.

5. The apparatus according to claim 4, wherein the threshold deviation is 10% of the theoretical Benford distribution.

6. The apparatus according to claim 1, wherein the Benford analysis is performed on a second leading digit of the fields within the identified records.

7. The apparatus according to claim 1, wherein the Benford analysis is performed on a third leading digit of the fields within the identified records.

8. The apparatus according to claim 1, wherein the Benford analysis is performed on first and second leading digits of the fields within the identified records.

9. The apparatus according to claim 1, wherein the Benford analysis is performed on a combination of first, second and third leading digits of the fields within the identified records.

10. The apparatus according to claim 1, further comprising:
a display for presenting ordered records as a report, wherein the ordered records show records from the set of records in a descending order of said total score.

11. A method for identifying suspicious data records, each record comprising two or more numerical fields, said method comprising:
identifying, by one or more processors, a set of records to be aggregated for analysis;
identifying, by one or more processors, fields within identified records, from the set of records, that are appropriate for a Benford analysis;
calculating, by one or more processors, a Benford distribution for each identified field;
summing, by one or more processors, a total score for each record from the set of records, wherein each total score comprises a summation of deviant values for each appropriate field value within said each record, wherein a deviant value represents a difference between a calculated Benford distribution for said each field and a theoretical Benford distribution for said each field; and
selecting, by one or more processors, a record from the set of records according to a highest said total score.

12. The method according to claim 11, wherein the Benford analysis is performed on a leading digit of the fields within the identified records.

13. The method according to claim 11, wherein the deviant value is a binary value that represents whether a deviation from an acquired Benford distribution is within or outside of a threshold deviation.

14. The method according to claim 13, wherein the threshold deviation is a percentage of the theoretical Benford distribution.

15. The method according to claim 14, wherein the threshold deviation is 10% of the theoretical Benford distribution.

16. The method according to claim 11, wherein the Benford analysis is performed on a second leading digit of the fields within the identified records.

17. The method according to claim 11, wherein the Benford analysis is performed on a third leading digit of the fields within the identified records.

18. The method according to claim 11, wherein the Benford analysis is performed on a combination of first, second and third leading digits of the fields within the identified records.

19. A computer program product for identifying suspicious data records, each record comprising two or more numerical fields, the computer program product comprising a computer-readable storage medium having program code embodied therewith, the program code readable and executable by a processor to perform a method comprising:
identifying a set of records to be aggregated for analysis;
identifying fields within the identified records that are appropriate for a Benford analysis;
calculating, for each identified field, a Benford distribution for said each identified field;
summing a total score for each record from the set of record, wherein each total score comprises a summation of deviant values for each appropriate field value within said each record, wherein a deviant value represents a difference between a calculated Benford distribution for said each field and a theoretical Benford distribution for said each field; and
selecting records from the set of records according to a highest said total score.

20. The computer program product of claim 19, wherein the Benford analysis is performed on a leading digit of the fields within the identified records.
